(19) United States
(12) Patent Application Publication
(10) Pub. No.: US 2017/0221331 A1
(43) Pub. Date: Aug. 3, 2017

(54) Smoke Detection System

(71) Applicant: Nelson Vargas, Maiden, MA (US)

(72) Inventor: Nelson Vargas, Maiden, MA (US)

(21) Appl. No.: 15/008,761

(22) Filed: Jan. 28, 2016

(51) Int. Cl. G08B 17/10; A47G 1/06; G08B 3/10

(52) U.S. Cl. CPC G08B 17/10; G08B 3/10; A47G 1/0616

(57) ABSTRACT

A smoke detection system for PURPOSE includes a picture frame that may have a picture mounted thereto. The picture frame displays the picture. A smoke detector is coupled to the picture frame and the smoke detector detects smoke. The smoke detector selectively emits an audible alarm when the smoke detector detects smoke.

### BACKGROUND OF THE DISCLOSURE

### Field of the Disclosure

The disclosure relates to alarm devices and more particularly pertains to a new alarm device for combining a picture frame and a smoke detector.

### SUMMARY OF THE DISCLOSURE

An embodiment of the disclosure meets the needs presented above by generally comprising a picture frame that may have a picture mounted thereto. The picture frame displays the picture. A smoke detector is coupled to the picture frame and the smoke detector detects smoke. The smoke detector selectively emits an audible alarm when the smoke detector detects smoke.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a smoke detection system according to an embodiment of the disclosure.

FIG. 2 is a back perspective view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a perspective view of an alternative embodiment of the disclosure.

### DESCRIPTION OF THE PREFERRED EMBODIMENT

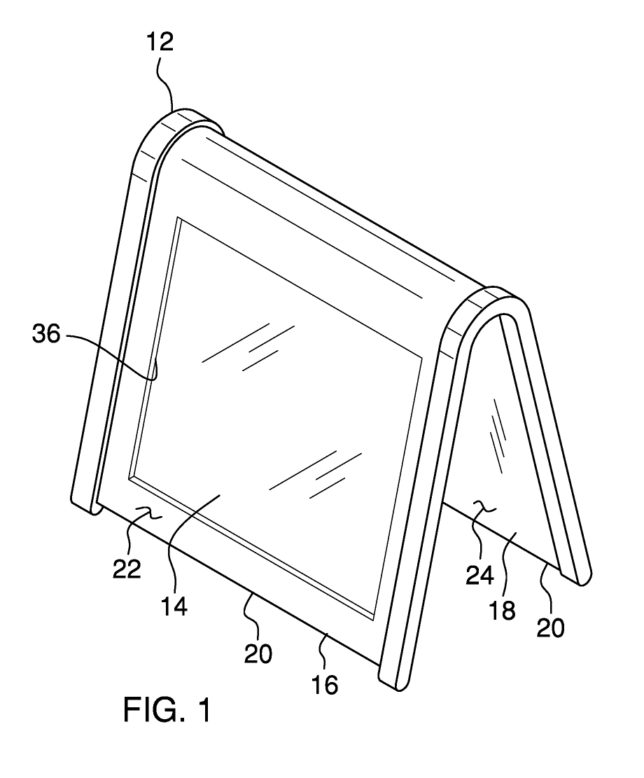

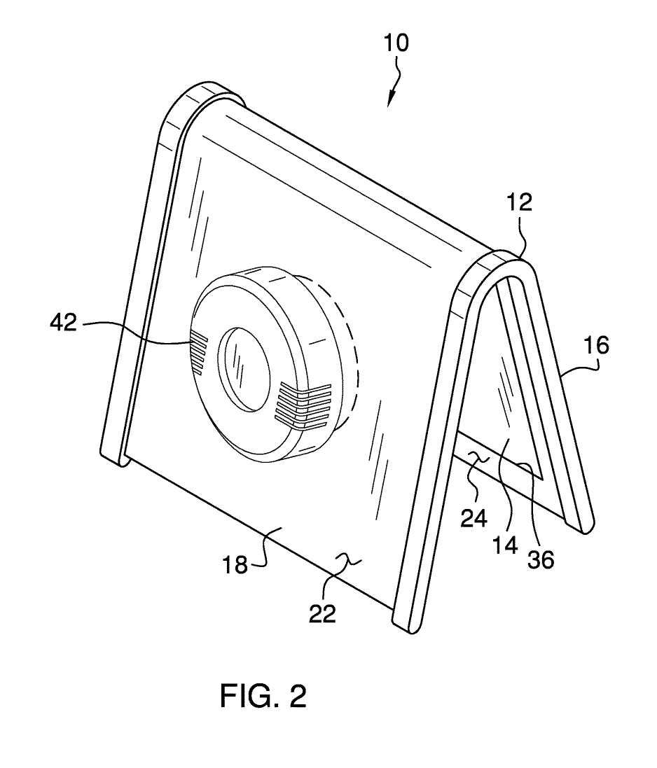

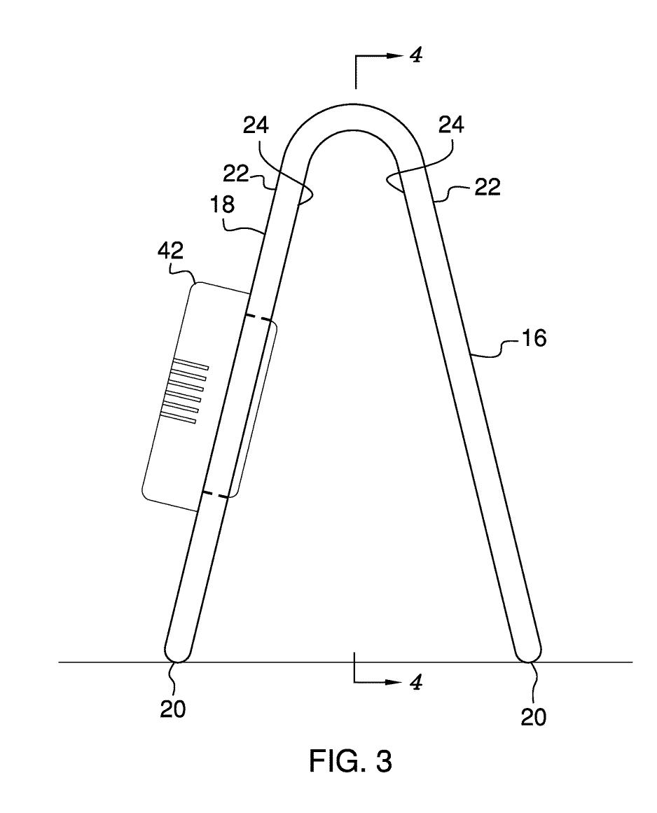

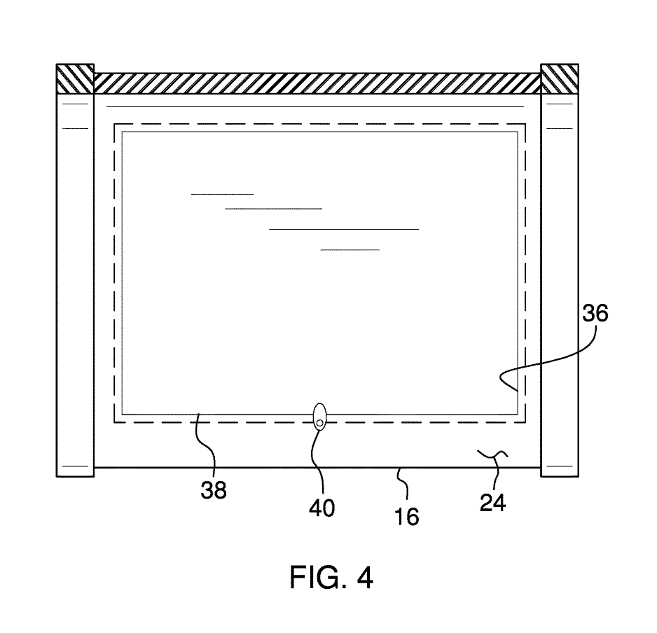

With reference now to the drawings, and in particular to FIGS. 1 through 5 thereof, a new alarm device embodying the principles and concepts of an embodiment of the disclosure and generally designated by the reference numeral 10 will be described.

As best illustrated in FIGS. 1 through 5, the smoke detection system 10 generally comprises a picture frame 12 that may have a picture 14 mounted thereto. Thus, the picture frame 12 may display the picture 14. The picture frame 12 comprises a first panel 16 that is coupled to a second panel 18. Each of the first panel 16 and the second panel 18 has a free end 20. The free end 20 corresponding to each of the first panel 16 and the second panel 18 is spaced apart from each other. Thus, the picture frame 12 forms a triangular shape.

The free end 20 corresponding to each of the first panel 16 and the second panel 18 may be positioned on a support surface. Each of the first panel 16 and the second panel 18 has a first surface 22 and a second surface 24. The first panel 16 has an opening 36 extending through the corresponding first surface 22 and the corresponding second surface 24. Thus, the picture 14 may be positioned in the opening 36.

A cover 38 is removably coupled to the second surface 24 corresponding to the first panel 16. The cover 38 is positioned over the opening 36 and the cover 38 retains the picture 14 in the opening 36. A clasp 40 is movably coupled to the second surface 24 corresponding to the first panel 16. The clasp 40 may be manipulated to retain the cover 38 on the second surface 24.

A smoke detector 42 is coupled to the picture frame 12. Thus, the smoke detector 42 may detect smoke. The smoke detector 42 may comprise an electronic smoke detector or the like. Moreover, the smoke detector 42 may detect carbon monoxide. The smoke detector 42 selectively emits an audible alarm when the smoke detector 42 detects smoke or carbon monoxide. The smoke detector 42 may be positioned on the second panel 18.

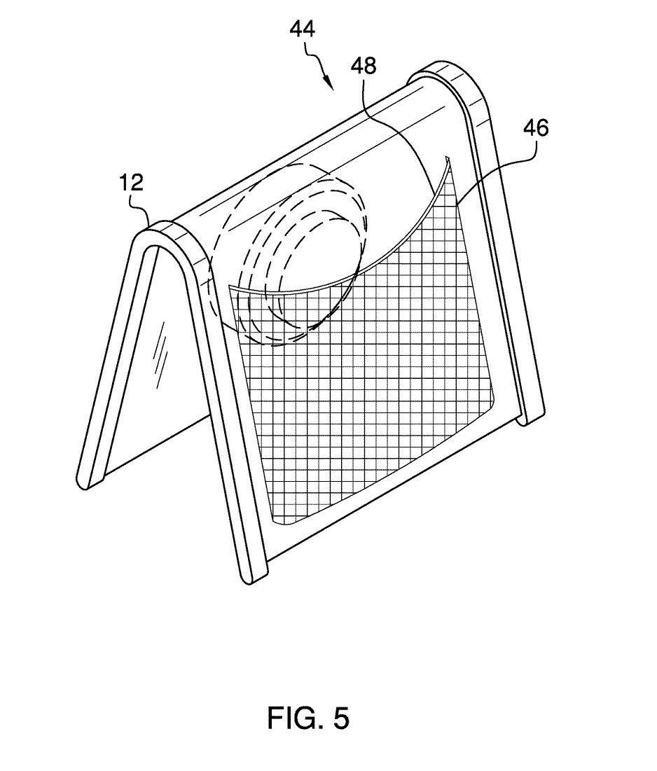

In an alternative embodiment 44 as shown in FIG. 5, a net 46 may be coupled to first surface 22 corresponding to the first panel 16. The net 46 has a top end 48 and the top end 48 forms an opening with respect to the first panel 16. Thus, the net 46 may store an object. The net 46 may be comprised of a resiliently stretchable material.

In use, the picture 14 is positioned in the picture frame 12. The picture frame 12 is positioned to display the picture 14. The smoke detector 42 emits the audible alarm when the smoke detector 42 detects smoke. Thus, the smoke detector 42 facilitates a user to be notified of a potential fire. The picture frame 12 may be positioned at any selected location. Thus, the smoke detector 42 is portable.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smoke detection system being configured to display a picture, said system comprising:
a picture frame being configured to have a picture mounted thereto thereby facilitating said picture frame to display the picture, wherein said picture frame comprises a first panel being coupled to a second panel by an arcuate section joining respective upper ends of each of said first panel and said second panel, each of said first panel and said second panel having a free end, said free end corresponding to each of said first panel and said second panel being spaced apart from each other, said free end corresponding to each of said first panel and said second panel being configured to be positioned on a support surface, each of said first panel and said second panel having a first surface and a second surface; and
a smoke detector being coupled to said picture frame such that said smoke detector extends from an outwardly directed face of said second panel relative to said first panel wherein said smoke detector is configured to detect smoke, said smoke detector selectively emitting an audible alarm when said smoke detector detects smoke.

2. (canceled)

3. The system according to claim 1, wherein:
said picture frame includes a first panel having a first surface and a second surface; and
said first panel has an opening extending through said corresponding first surface and said corresponding second surface wherein said opening in said first panel is configured to have the picture positioned therein.

4. The system according to claim 3, further comprising a cover being removably coupled to said second surface corresponding to said first panel, said cover being positioned over said opening wherein said cover is configured to retain the picture in said opening.

5. A smoke detection system being configured to display a picture, said system comprising:
a picture frame being configured to have a picture mounted thereto thereby facilitating said picture frame to display the picture, said picture frame comprising a first panel being coupled to a second panel by an arcuate section joining respective upper ends of each of said first panel and said second panel, each of said first panel and said second panel having a free end, said free end corresponding to each of said first panel and said second panel being spaced apart from each other, said free end corresponding to each of said first panel and said second panel being configured to be positioned on a support surface, each of said first panel and said second panel having a first surface and a second surface, said first panel having an opening extending through said corresponding first surface and said corresponding second surface wherein said opening is configured to have the picture positioned therein;
a cover being removably coupled to said second surface corresponding to said first panel, said cover being positioned over said opening wherein said cover is configured to retain the picture in said opening; and
a smoke detector being coupled to said picture frame such that said smoke detector extends from an outwardly directed face of said second panel relative to said first panel wherein said smoke detector is configured to detect smoke, said smoke detector selectively emitting an audible alarm when said smoke detector detects smoke, said smoke detector being positioned on said second panel.
